(19) United States
(12) Patent Application Publication
(10) Pub. No.: US 2011/0159323 A1
(43) Pub. Date: Jun. 30, 2011

(54) Secondary battery

(76) Inventor: Bong-Young Kim, Yongin-si (KR)

(21) Appl. No.: 12/926,729

(22) Filed: Dec. 7, 2010

(30) Foreign Application Priority Data
Dec. 28, 2009 (KR) 10-2009-0131491

(51) Int. Cl. H01M 10/42; H01M 10/04; H01R 43/02

(52) U.S. Cl. 429/7; 29/623.1; 29/878

(57) ABSTRACT

A secondary battery includes a bare cell, and a protection circuit module electrically connected to the bare cell, the protection circuit module including a circuit board including a welding hole therethrough and a welding pad adjacent to the welding hole, and an electrode terminal tab positioned between the circuit board and the bare cell, the electrode terminal tab having a terminal connection portion and a board connection portion electrically connected to the bare cell and the circuit board, respectively, wherein the welding hole exposes the terminal connection portion of the electrode terminal tab, and the welding pad is electrically connected to the board connection portion of the electrode terminal tab.

### BACKGROUND

1. Field

Example embodiments relate to a secondary battery. More particularly, example embodiments relate to a secondary battery having a protection circuit with a secured component mounting space.

2. Description of the Related Art

Unlike primary batteries, i.e., non-rechargeable batteries, secondary batteries refer to batteries that can recharge and discharge. The secondary batteries may be used in high-technology electronic devices, e.g., cellular phones, notebook computers, camcorders, etc.

For example, a secondary battery, e.g., a prismatic type secondary battery, may include a can, e.g., a prismatic type can, having an electrode assembly accommodated therein, a bare cell having a cap assembly for sealing an opening of the can, and a protection circuit module (PCM) electrically connected to the bare cell to control the charge/discharge and operation of the secondary battery. The PCM may include a circuit board with control components, a positive temperature coefficient (PTC) element, and the like.

### SUMMARY

Embodiments are directed to a secondary battery, which substantially overcomes one or more of the problems due to the limitations and disadvantages of the related art.

It is therefore a feature of an embodiment to provide a secondary battery having a protection circuit module with a secured component mounting space.

It is another feature of an embodiment to provide a method of forming a secondary battery having a protection circuit module with a secured component mounting space.

At least one of the above and other features and advantages may be realized by providing a secondary battery, including a bare cell and a protection circuit module electrically connected to the bare cell, the protection circuit module having a circuit board including a welding hole therethrough and a welding pad adjacent to the welding hole, and an electrode terminal tab positioned between the circuit board and the bare cell, the electrode terminal tab having a terminal connection portion and a board connection portion electrically connected to the bare cell and the circuit board, respectively, wherein the welding hole exposes the terminal connection portion of the electrode terminal tab, and the welding pad is electrically connected to the board connection portion of the electrode terminal tab.

The welding pad may include an upper pad on an upper surface of the circuit board and including a copper foil, a lower pad on a lower surface of the circuit board and including a copper foil, the lower pad being electrically connected to the board connection portion of the electrode terminal tab, and at least one via hole through the circuit board and electrically connecting the upper and lower pads. Upper surfaces of the upper pad and circuit board may be substantially level, and lower surfaces of the lower pad and circuit board may be substantially level.

The welding pad may be implemented so that the copper foil is exposed by removing the upper film of the circuit board. The welding pad may further include one or more via holes for passing through the circuit board at a position adjacent to the welding pad, a conducting block positioned beneath the via hole to be electrically connected to the welding pad through the via hole, and a lead plate for electrically connecting the conducting block and the board connection portion of the electrode terminal tab to each other therebetween. The PTC element may be electrically connected between the lead plate and the board connection portion of the electrode terminal tab.

The PTC element may be mounted in the form of a chip on one surface of the circuit board.

The secondary battery may further include an anti-corrosion layer coated on the welding pad.

The electrode terminal tab may be a negative electrode terminal tab. The terminal connection portion of the electrode terminal tab may be electrically connected to a negative electrode terminal of the bare cell by resistance welding.

A size of the welding hole may correspond to a size of a single welding rod.

At least one of the above and other features and advantages may be realized by providing a method of forming secondary battery, including forming a bare cell and forming a protection circuit module electrically connected to the bare cell, the protection circuit module having a circuit board including a welding hole and a welding pad adjacent the welding hole, and an electrode terminal tab positioned between the circuit board and the bare cell, the electrode terminal tab having a terminal connection portion and a board connection portion electrically connected to the bare cell and the circuit board, respectively, wherein the welding hole exposes the terminal connection portion of the electrode terminal tab, and the welding pad being electrically connected to the board connection portion of the electrode terminal tab.

The terminal connection portion of the electrode terminal tab may be electrically connected to the bare cell by resistance welding. Resistance welding may include contacting a first welding rod to the terminal connection portion through the welding hole, and contacting a second welding rod to the welding pad.

The welding pad may be formed by forming upper and lower pads on the circuit board, the upper pad being exposed by removing an upper film of the circuit board, and the lower pad being exposed by removing a lower film of the circuit board.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates an exploded perspective view of a secondary battery according to an embodiment.

FIG. 2 illustrates a side view of a secondary battery according to an embodiment.

FIG. 3 illustrates an enlarged schematic representation of a stage in a method of welding a secondary battery according to an embodiment.

FIG. 4 illustrates a side view of a secondary battery according to another embodiment.

### DETAILED DESCRIPTION

Korean Patent Application No. 10-2009-0131491, filed on Dec. 28, 2009, in the Korean Intellectual Property Office, and entitled: “Secondary Battery,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of elements and regions may be exaggerated for clarity of illustration. It will also be understood that when an element or layer is referred to as being “on” another element or substrate, it can be directly on the other element or substrate, or intervening elements may also be present. Further, it will be understood that when an element is referred to as being “connected to” another element, they can be directly connected, and one or more intervening elements may also be present. In addition, it will also be understood that when an element is referred to as being “between” two elements, it can be the only element between the two elements, or one or more intervening elements may also be present. Like reference numerals refer to like elements throughout.

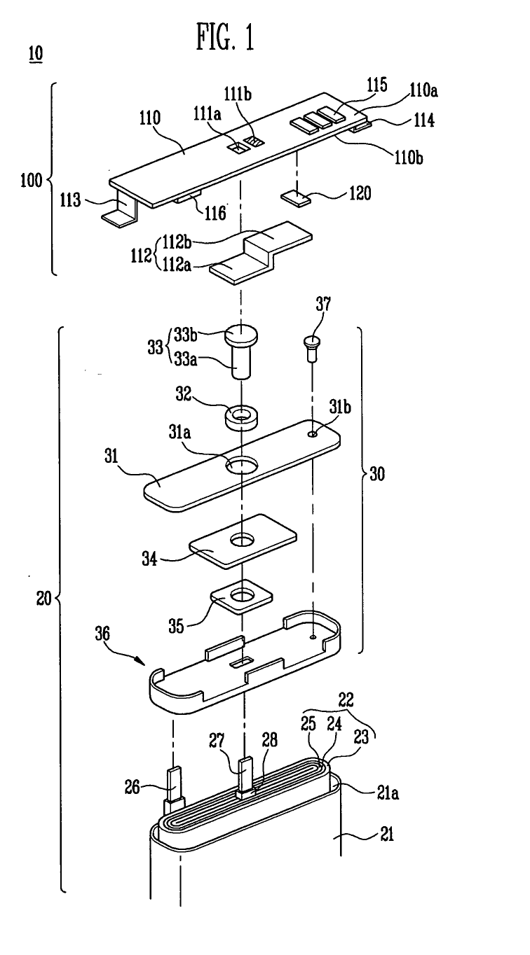

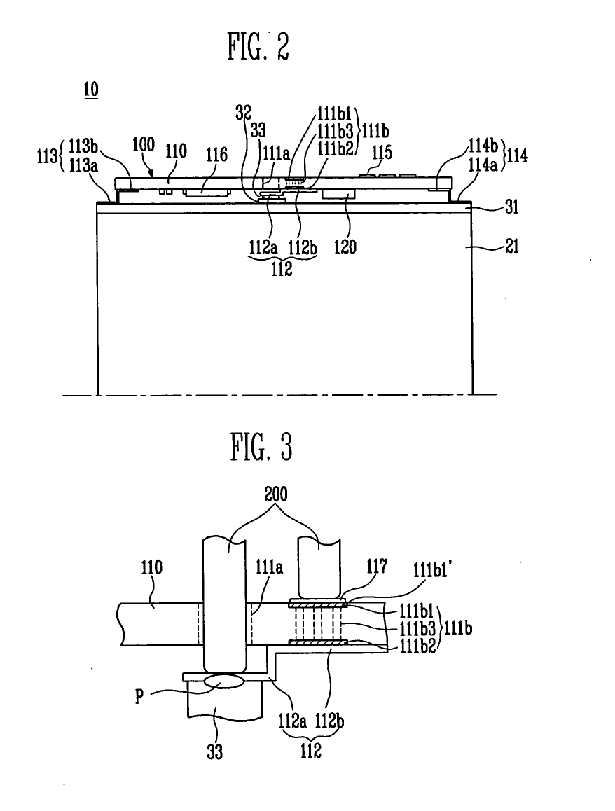

FIG. 1 illustrates an exploded perspective view of a secondary battery according to an embodiment. FIG. 2 illustrates a side view of the secondary battery in FIG. 1.

Referring to FIGS. 1 and 2, a secondary battery 10 according to an embodiment may include a bare cell 20 and a protection circuit board 100. The protection circuit board 100 may be physically and electrically connected to the bare cell 20.

The bare cell 20 may include a can 21, an electrode assembly 22 accommodated in the can 21, and a cap assembly 30 for sealing an opening 21a of the can 21. The protection circuit board 100 may be connected to the bare cell 20 via the cap assembly 30.

The can 21 may be a, e.g., metallic, container formed in any suitable shape, e.g., approximately a rectangular parallelepiped shape, and the opening 21a may be formed at one end portion of the can 21. The can 21 may be formed, e.g., using a deep drawing. Therefore, the can 21 may serve as a terminal. The can 21 may be formed of a light metal material, e.g., aluminum or an aluminum alloy.

The electrode assembly 22 may be formed in a jelly roll shape by winding a positive electrode plate 23, a negative electrode plate 25, and a separator 24 interposed therebetween. For example, the positive electrode plate 23 may be formed by coating a positive electrode active material, e.g., cobalt acid lithium, on a first collector, e.g., an aluminum foil, and the negative electrode plate 25 may be formed by coating a negative electrode active material, e.g., carbon, on a second collector, e.g., a copper foil. The separator 24 may be formed of, e.g., polyethylene, polypropylene, and/or a co-polymer of polyethylene and polypropylene.

The electrode assembly 22 may have a positive electrode tab 26 attached to the positive electrode plate 23 to be extracted from the positive electrode plate 23, and a negative electrode tab 27 attached to the negative electrode plate 25 to be extracted from the negative electrode plate 25. Each of the positive and negative electrode tabs 26 and 27 may be partially wound by an insulation tape 28.

The cap assembly 30 may include a cap plate 31, a gasket 32, a negative electrode terminal 33, an insulation plate 34, a terminal plate 35, an insulation case 36, and a stopper 37. The protection circuit board 100 may be connected to the cap assembly 30 via the cap plate 31 and the negative electrode terminal 33.

The cap plate 31 may have a terminal through-hole 31a formed at an approximately center thereof. When the negative electrode terminal 33 is connected to the cap plate 31, the gasket 32 may be positioned at an outer circumferential portion of the negative electrode terminal 33 so that the terminal through-hole 31a passes through the gasket 32. That is, the negative electrode terminal 33 may extend through the terminal through-hole 31a, so the gasket 32 surrounds a lower portion 33a of the negative electrode terminal 33 and an upper portion 33b of the negative electrode terminal 33 extends above the gasket 32. An electrolyte injection hole 31b may be formed at one side of the cap plate 31. After injection of the electrolyte is finished, the electrolyte injection hole 31b may be sealed by the stopper 37.

The insulation plate 34 may be disposed beneath the cap plate 31, and the terminal plate 35 may be disposed beneath the insulation plate 34. Thus, the cap plate 31 and the terminal plate 35 may be isolated from each other by the insulation plate 34.

The terminal plate 35 may be connected to a lower end portion of the negative electrode terminal 33. The negative electrode plate 25 of the electrode assembly 22 may be electrically connected to the negative electrode terminal 33 through the negative electrode tab 27 and the terminal plate 35, and the positive electrode plate 23 of the electrode assembly 22 may be electrically connected to the cap plate 31 through the positive electrode tab 26.

The cap plate 31 may serve as a positive electrode terminal. The insulation case 36 may be positioned on an upper portion of the electrode assembly 22, so that the electrode assembly 22 and the cap assembly 30 may be isolated from each other.

The protection circuit module 100 may include a circuit board 110. An external connection terminal 115, various types of control components 116, a positive temperature coefficient (PTC) element 120, and the like may be formed on upper and lower surfaces of the protection circuit module 100.

As further illustrated in FIGS. 1 and 2, electrode terminal tabs 112, 113, and 114 may be positioned between the circuit board 110 and the bare cell 20. The electrode terminal tabs 112, 113, and 114 may be included in the protection circuit module 100 or may be separate elements therefrom.

The electrode terminal tabs 112, 113, and 114 may include positive electrode tabs 113 and 114, and a negative electrode tab 112. Each of the electrode terminal tabs 112, 113, and 114 may include a respective terminal connection portion 112a, 113a, and 114a electrically connected to the bare cell 20, and a respective board connection portion 112b, 113b, and 114b electrically connected and/or fixed to the circuit board 110. The terminal connection portions 112a, 113a and 114a, and the board connection portions 112b, 113b, and 114b may be, e.g., parallel to each other, and integrally formed to have a step structure or may be formed into a structure in which they are connected to each other by a separate plate.

Example embodiments are not limited thereto. Hereinafter, it is assumed that the electrode terminal tab 112 connected to an approximately center of the circuit board 110 is a negative electrode terminal tab, and the electrode terminal tabs 113 and 114 respectively connected to both sides, e.g., opposite edges, of the circuit board 110 are positive electrode terminal tabs. However, in some cases, one of the electrode terminal tabs 113 and 114 respectively connected to both sides of the circuit board 110 may be set as a dummy plate for maintaining a space between the bare cell 20 and the protection circuit module 100.

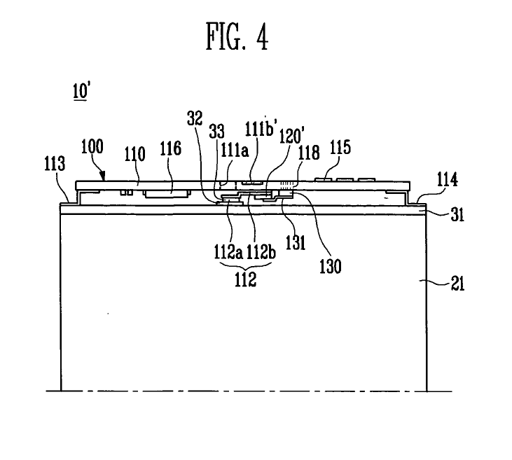

As illustrated in FIG. 2, the terminal connection portion 112a of the negative electrode terminal tab 112 may be, e.g., physically and electrically, connected to the negative electrode terminal 33 of the bare cell 20 by welding. For example, the terminal connection portion 112a may be substantially parallel to the cap plate 31, and may be positioned on, e.g., directly on, the upper portion 33b of the negative electrode terminal 33. The board connection portions 112b may be connected between the terminal connection portion 112a and a lower surface 110b of the circuit board 110, i.e., a surface facing the bare cell 20. The welding of the terminal and board connection portions 112a and 112b to the negative electrode terminal 33 and the circuit board 110, respectively, will be explained in more detail below with reference to FIG. 3.

The terminal connection portions 113a and 114a of the positive electrode terminal tabs 113 and 114 may be electrically connected to left and right sides, i.e., both sides of the upper surface of the cap plate 31 of the bare cell 20 by welding, respectively. Thus, the cap plate 31 may serve as a positive electrode terminal.

In the secondary battery 10, current generated from the negative electrode terminal 33 of the bare cell 20 is conducted to the circuit board 110 through the negative electrode terminal tab 112. The negative electrode terminal tab 112 may be electrically connected to the PTC element 120 mounted in the form of a chip through a pattern (not shown) formed on the circuit board 110. Thus, when the temperature and/or current, e.g., charge/discharge, of the secondary battery are excessive, the flow of current may be cut off by the PTC element 120, and accordingly, the stability of the secondary battery 10 may be ensured.

As further illustrated in FIGS. 1 and 2, the protection circuit module 100 may include a welding hole 111a and a welding pad 111b. The welding hole 111a may be formed through the circuit board 110 above the terminal connection portion 112a in order to expose at least a portion of the terminal connection portion 112a of the negative electrode terminal tab 112. A size of the welding hole 111a may be reduced, i.e., sufficiently small to enable insertion of e.g., only, a single welding rode. The welding pad 111b may be formed through the circuit board 110 above the board connection portion 112b, and may be adjacent the welding hole 111a. The welding pad 111b may be electrically connected to the board connection portion 112b of the negative electrode terminal tab 112, so another welding rod may contact the welding pad 111b. The welding hole 111a and the welding pad 111b may be spaced apart from each other horizontally.

For example, as illustrated in FIG. 2, the welding pad 111b may include an upper pad 111b1 on the circuit board 110, a lower pad 111b2 on the circuit board 110 and electrically connected to the board connection portion 112b of the negative electrode terminal tab 112, and one or more via holes 111b3 through the circuit board 110 between the upper and lower pads 111b1 and 111b2. For example, the upper pad 111b1 may be on an upper surface 110a of the circuit board 110, and may have a copper foil exposed by removing an upper film of the circuit board 110. The lower pad 111b2 may be on a lower surface 110b of the circuit board 110, and may have a copper foil exposed by removing a lower film of the circuit board 110.

Conductive patterns may be formed in the circuit board 110, so the upper and lower pads 111b1 and 111b2 may be electrically connected to each other through the via hole 111b3. That is, the via hole 111b3 may be designed to have one or more via holes, so that the upper and lower pads 111b1 and 111b2 may be electrically connected to each other therethrough. For example, the upper and lower pads 111b1 and 111b2 may overlap each other, and a plurality of via holes 111b3 may be formed therebetween so that a large amount of current may flow therethrough.

As described above, example embodiments may include a small-sized welding hole 111a in the circuit board 110 of the protection circuit module 100 that corresponds to a size of single welding rod, e.g., a width of the welding hole 111a may be only slightly larger than a width of a welding rod so that only one welding rod may be inserted into the welding hole 111a. Further, example embodiments may include a welding pad 111b in the vicinity of the welding hole 111a, so that a current path may be formed by contacting another welding rod with the welding pad 111b. As such, a dead space on the circuit board 110 may be reduced, and a component mounting space in the protection circuit module 100 may be secured. Therefore, stability of the secondary battery 10 may be enhanced, e.g., example embodiments may be usefully applied to slim secondary batteries and the like.

In contrast, a conventional secondary battery may include a large welding hole, e.g., sufficient for at least two welding rods to be inserted therethrough, in order to form a current path for resistance welding. However, such a large welding hole may reduce a component mounting space on the circuit board. Particularly, it may be difficult to sufficiently secure a component mounting space in a slim secondary battery, thereby increasing failure probability of the battery.

FIG. 3 illustrates an enlarged view of a welding method of the secondary battery according to an embodiment. It is noted that FIG. 3 illustrates a resistance welding method of the negative electrode terminal 33 and the negative electrode terminal tab 112.

Referring to FIG. 3, the negative electrode terminal 33 may be welded, e.g., via resistance welding, to the negative electrode terminal tab 112. For example, when resistance welding is used, two welding rods 200 may form a current path and generate heat due to contact resistance.

There are various welding methods. However, if the negative electrode tab 112 is made of a nickel material, it may be difficult to perform ultrasonic welding due to the insolubility of nickel. It may also be difficult to perform laser welding, since a laser beam may be conducted to the protection circuit module 100 and lower its reliability. Hence, the negative electrode terminal 33 may be connected to the negative electrode terminal tab 112 by resistance welding.

The resistance welding of the negative electrode terminal 33 will be described in detail. Referring to FIG. 3, one welding rod 200 may pass through the welding hole 111a to contact the terminal connection portion 112a of the negative electrode terminal tab 112, and the other welding rod 200 may contact the upper pad 111b1 of the welding pad 111b. In this state, current may flow, so that the negative electrode terminal 33 may be connected to the negative electrode terminal tab 112 by resistance welding.

In detail, when a current path is formed, i.e., when current flows through the rod 200 contacting the terminal connection portion 112a, a joint portion P between the negative electrode terminal 33 and the terminal connection portion 112a of the negative electrode terminal tab 112 is melted by the heat generated due to the contact resistance, so that the negative electrode terminal 33 and the negative electrode terminal tab 112 are electrically connected to each other. Here, the current path proceeds from the welding rod 200 inserted into the welding hole 111a to the welding rod 200 on the welding pad 111b via the negative electrode terminal tab 112 and the welding pad 111b.

As illustrated in FIG. 3, the welding pad 111b may include an anti-corrosion layer 117 coated on an upper surface 111b1′ of the welding pad 111b, e.g., on a portion facing an exterior of the protection module circuit 100, to prevent exposure of the upper pad 111b1 to the exterior of the protection circuit module 100. Therefore, corrosion of the welding pad 111b may be prevented or substantially minimized. For example, the anti-corrosion layer 117 may be formed by performing nickel plating on the upper pad 111b1. Although not shown, a gold-plated layer and the like may further be formed on an uppermost portion of the upper pad 111b1, so that the welding pad 111b may be used as a test pad in function testing.

FIG. 4 illustrates a side view of a secondary battery according to another embodiment. A secondary battery 10′ in FIG. 4 may be substantially the same as the secondary battery 10 in FIG. 2, with the exception of having a PCT element connected to the circuit board by point welding or the like, instead of being mounted in the form of a chip on the circuit board.

Referring to FIG. 4, the secondary battery 10′ may include a welding pad 111b′ and a via hole 118 through the circuit board 110 at a position adjacent to the welding pad 111b′. The welding pad 111b′ may have a copper foil exposed by removing an upper film of the circuit board 110, and may be electrically connected to the via hole 118 by a pattern (not shown) formed on the circuit board 110. The via hole 118 may be spaced apart horizontally from the welding pad 111b′.

A conducting block 130 and a lead plate 131 may be formed below the via hole 118. The conducting block 130 may be electrically connected to the welding pad 111b′ through the via hole 118, and the lead plate 131 may electrically connect the conducting block 130 and the board connection portion 112b of the negative electrode terminal tab 112 via a PTC element 120′ therebetween. That is, the PTC element 120′ may be electrically connected between the lead plate 131 and the board connection portion 112b of the negative electrode terminal tab 112, and the board connection portion 112b of the negative electrode terminal tab 112 may be spaced apart from the circuit board 110 by a predetermined distance. The board connection portion 112b of the negative electrode terminal tab 112 may be connected to the via hole 118 via the PTC element 120′, the lead plate 131, and the conducting block 130.

The conducting block 130 and the lead plate 131 may be formed, e.g., of nickel. For example, the conducting block 130 may be implemented as a nickel block, and the lead plate 131 may be implemented as a nickel plate.

It is noted that for convenience of illustration, FIG. 4 illustrates the negative electrode terminal tab 112, the PTC element 120′, and the lead plate 131 as different components. However, the negative electrode terminal tab 112, the PTC element 120′, and the lead plate 131 may be implemented as an integrated component, e.g., a single component.

As described above, in the secondary battery 10′, a method in which the negative electrode terminal 33 is connected to the negative electrode terminal tab 112 by resistance welding is almost identical to that in the embodiment illustrated in FIG. 3. However, the current path in the resistance welding in FIG. 4 may proceed from a welding rod (not shown) that contacts the terminal connection portion 112a of the negative electrode terminal tab 112 through the welding hole 111a to another welding rod (not shown) on the welding pad 111b′ via the negative electrode terminal tab 112, the PTC element 120′, the lead plate 131, the conducting block 130, the via hole 118, and the welding pad 111b′.

As described above, in a secondary battery according to an embodiment, a size of a welding hole formed in a circuit board of a protection circuit module may be reduced, so that one welding rod may be inserted into the welding hole, and another welding rod may contact a welding pad in the vicinity of the welding hole, thereby forming a current path. Accordingly, a dead space on the circuit board may be reduced, thereby securing a component mounting space.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A secondary battery, comprising:
a bare cell; and
a protection circuit module electrically connected to the bare cell, the protection circuit module including:
a circuit board including a welding hole therethrough and a welding pad adjacent to the welding hole, and
an electrode terminal tab positioned between the circuit board and the bare cell, the electrode terminal tab having a terminal connection portion and a board connection portion electrically connected to the bare cell and the circuit board, respectively,
wherein the welding hole exposes the terminal connection portion of the electrode terminal tab, and the welding pad is electrically connected to the board connection portion of the electrode terminal tab.

2. The secondary battery as claimed in claim 1, wherein the welding pad includes:
an upper pad on an upper surface of the circuit board and including a copper foil;
a lower pad on a lower surface of the circuit board and including a copper foil, the lower pad being electrically connected to the board connection portion of the electrode terminal tab; and
at least one via hole through the circuit board and electrically connecting the upper and lower pads.

3. The secondary battery as claimed in claim 2, wherein upper surfaces of the upper pad and circuit board are substantially level, and lower surfaces of the lower pad and circuit board are substantially level.

4. The secondary battery as claimed in claim 1, wherein the welding pad includes:
a copper foil on an upper surface of the circuit board;
at least one via hole through the circuit board;
a conducting block electrically connected to the welding pad through the via hole, the via hole being on the conducting block; and
a lead plate electrically connecting the conducting block and the board connection portion of the electrode terminal tab.

5. The secondary battery as claimed in claim 4, further comprising a positive temperature coefficient (PTC) in the circuit board, the PTC being electrically connected between the lead plate and the board connection portion of the electrode terminal tab.

6. The secondary battery as claimed in claim 1, further comprising a positive temperature coefficient (PTC) in the circuit board, the PTC being a chip on one surface of the circuit board.

7. The secondary battery as claimed in claim 1, further comprising an anti-corrosion layer on the welding pad.

8. The secondary battery as claimed in claim 1, wherein the electrode terminal tab is a negative electrode terminal tab.

9. The secondary battery as claimed in claim 8, wherein the terminal connection portion of the electrode terminal tab is electrically connected to a negative electrode terminal of the bare cell.

10. The secondary battery as claimed in claim 1, wherein a size of the welding hole corresponds to a size of a single welding rod.

11. A method of forming a secondary battery, including:
forming a bare cell; and
forming a protection circuit module electrically connected to the bare cell, the protection circuit module including:
a circuit board including a welding hole and a welding pad adjacent the welding hole, and
an electrode terminal tab positioned between the circuit board and the bare cell, the electrode terminal tab having a terminal connection portion and a board connection portion electrically connected to the bare cell and the circuit board, respectively,
wherein the welding hole exposes the terminal connection portion of the electrode terminal tab, and the welding pad being electrically connected to the board connection portion of the electrode terminal tab.

12. The method as claimed in claim 11, wherein the terminal connection portion of the electrode terminal tab is electrically connected to the bare cell by resistance welding.

13. The method as claimed in claim 12, wherein resistance welding includes contacting a first welding rod to the terminal connection portion through the welding hole, and contacting a second welding rod to the welding pad.

14. The method as claimed in claim 11, wherein the welding pad is formed by forming upper and lower pads on the circuit board, the upper pad being exposed by removing an upper film of the circuit board, and the lower pad being exposed by removing a lower film of the circuit board.
